(19) United States
(12) Patent Application Publication
(10) Pub. No.: US 2002/0052181 A1
(43) Pub. Date: May 2, 2002

(54) Key switch system for wireless communication apparatuses

(76) Inventors: Min-Chieh Tsai, Taipei Hsien (TW); Chih-Jen Hsu, Taipei Hsien (TW); Te-Yu Liang, Taipei Hsien (TW)

Correspondence Address: Michael D. Bednarek, SHAWPITTMAN, 1650 Tysons Boulevard, McLean, VA, 22102-4859, US

(21) Appl. No.: 09/828,843

(22) Filed: Apr. 10, 2001

(30) Foreign Application Priority Data
Oct. 27, 2000 (TW) 089122859

(51) Int. Cl. H04B 5/00

(52) U.S. Cl. 455/41; 455/556

(57) ABSTRACT

A key switch system for switching in a cyclic pattern between a plurality of wireless communication apparatuses of a computer, comprising a function key, mounted on the computer, for generating an interrupt signal after depression; software for activating and deactivating the wireless communication apparatuses according to the signal, with one activated at a time; and a display window for displaying the activated/deactivated status of the wireless communication apparatuses; wherein cyclic switching between the wireless communication apparatuses are enacted by the depression of the function key; the wireless communication apparatuses include incompatible ones; and the cyclic pattern follows the sequence of, firstly, activating in turn each one of the apparatuses in a round and then, secondly, deactivating all of the apparatuses after a round is finished and starting another round.

### REFERENCE TO RELATED APPLICATIONS

The present application claims priority to Taiwan application NO. 089122859 entitled “Key switch system for wireless communication apparatuses” filed on Oct. 27, 2000.

### BACKGROUND OF THE INVENTION

1. Field of the Invention

The present invention relates to a key switch system in a computer system. More particularly, it relates to a key switch system for switching between a plurality of mutually incompatible wireless communication apparatuses installed on a computer system for the purpose of avoiding interference.

2. Description of the Related Art

Following the advances and developments of information technology, electronic devices capable of wireless communication, such as mobile phones and laptop computers, have been hailed as the way of the future. With the help of wireless technology, one is able to communicate in visual or audio format with another at virtually any particular space and time, thus breaking through barriers that hinder communication, while at the same time speeding up information exchanges between people and places, in such a way as to make the planet a global village.

In the field of personal computers, there exist several wireless communication protocols, two of which in particular are widely utilized in commercial use: the IEEE802.11 protocol and the bluetooth protocol.

The IEEE802.11 protocol is a rather developed networking technology, employing the so called direct sequence spread spectrum (DSSS) technique which confines transmissions of data within a particular bandwidth. Though advantageous for being hard to be detected by an intruder, it is vulnerable to interference when confronting interfering sources utilizing high bandwidth such as frequency hopping (FH) technique or microwaves. It so happens that the bluetooth protocol utilizes a frequency hopping technique, making the two protocols incompatible. Under such circumstances, whenever a bluetooth apparatus is nearby, a computer system wherein an IEEE802.11 apparatus is installed may suffer from reduced performance or even turn out to be inoperable in terms of wireless communication.

For the reason that the IEEE802.11 protocol and the bluetooth protocol are incompatible and thus cannot coexist, it has been the practice of the prior art that a computer system support only one of the two commonly used wireless communication protocols. In such case, the computer system may not work through the supported protocol simply because there exits an incompatible protocol in use in the surroundings. This is the most commonly encountered situation since, for the time being, different protocols are available and are utilized in different environments.

### SUMMARY OF THE INVENTION

In order to overcome the incompatibility problem described above, the inventor has devised a computer system supporting both the IEEE802.11 protocol as well as the bluetooth protocol, which allows a user to switch between the two wireless apparatuses wherever and whenever at his convenience, thus providing a solution to the inconvenience and interference problems arising out of prior art practices and at the same time enhancing the portability of the computer system.

As is common, control software is required to activate (turn on) or deactivate (turn off) a wireless communication apparatus installed on a computer system. When a user desires to activate or deactivate the apparatus, he simply points to a specific icon displayed on the screen by the mouse and clicks. Following the click, the software calls the driver to perform the task and the apparatus is activated or deactivated as desired. Now consider a computer system comprising both the IEEE802.11 communication module and the bluetooth communication module, each associated with controller software set up therein according to the prior art. When the user desires to switch from one of the modules (say, IEEE802.11) to the other (say, bluetooth), firstly he has to deactivate the IEEE802.11 module and/or close the software associated therewith, and then secondly he initiates the software associated with the bluetooth module and thereby activates the bluetooth module. It is often the case that these frequent and trivial operations of pointing to icons on the screen with the mouse may cause inconveniences for the user, and the inventor has devised a key switch in cooperation with a switch program for the purpose of switching between the two wireless modules. According to present invention, the user is able to switch form one module to the other simply by depressing the key. This makes the computer system easier to operate.

Therefore, the object of present invention is to provide a computer system with both an IEEE802.11 communication module and a bluetooth communication module, and a switch for switching between these two modules that is controllable by the user at his convenience.

Another object of present invention is to provide a switch for switching between two different wireless communication apparatuses. The depression of the switch leads to deactivating one, activating the other, or deactivating both of the two apparatuses.

Still another object of present invention is to provide a switch in the form of a key for easy use.

Still another object of present invention is to provide a display window for emitting light of different colors that correspond to different on/off status of the wireless communication modules.

Another object of present invention is to provide a switch program for instructing the computer system to switch between two different wireless communication apparatuses.

Another object of present invention is to provide a monitor program for detecting and monitoring whether the key switch has been depressed and thereby determining whether to call the switch program so as to switch between two different wireless communication apparatuses.

### BRIEF DESCRIPTION OF THE DRAWINGS

The following detailed description, which is given by way of example, and not intended to limit the invention to the embodiments described herein, can best be understood in conjunction with the accompanying drawings, in which:

FIG. 1 illustrates a key switch for wireless communication apparatuses as embodied according to the present invention.

FIG. 2 illustrates possible different status of the wireless communication apparatuses according to the present invention.

FIG. 3 illustrates a flow chart of one embodiment of the key switch system for wireless communication apparatuses according to the present invention.

FIG. 4 illustrates a flow chart of another embodiment of the key switch system for wireless communication apparatuses according to the present invention.

### DETAILED DESCRIPTION OF THE INVENTION

Though the following detailed description pertains to one particular embodiment wherein a laptop computer is equipped with two wireless communication apparatuses, it is to be understood that the present invention can be embodied in different computer systems such as mobile phones, personal digital assistants (PDA), webpads, or other internet appliances and portable electronics with wireless communication capabilities.

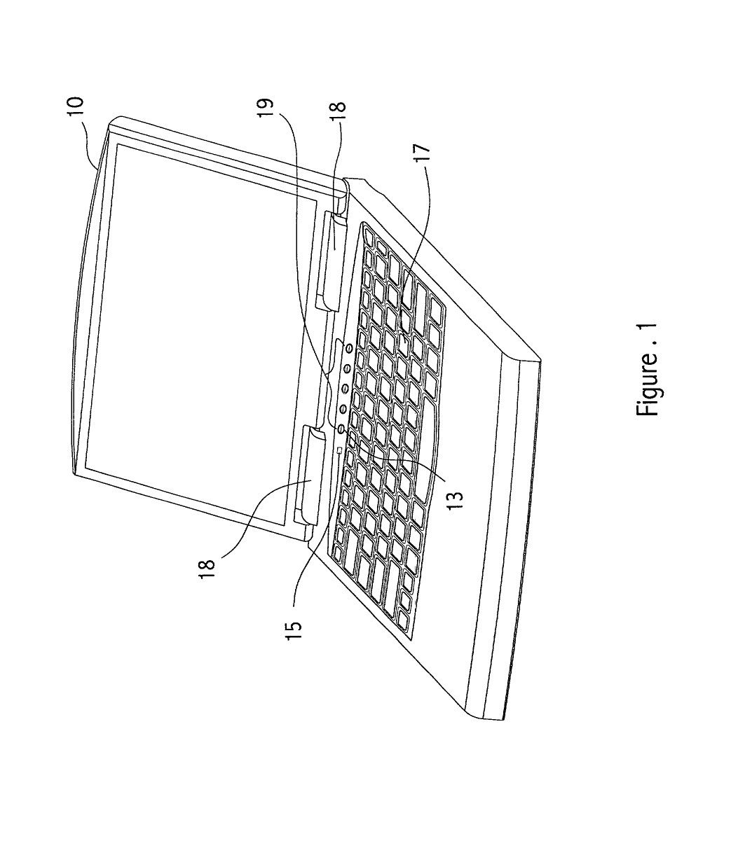

FIG. 1 illustrates a key switch for wireless communication apparatuses as embodied according to the present invention. Laptop computer 10 comprises the IEEE802.11 module and the bluetooth module for wireless communication, each of which is installed correspondingly inside the structure of one of the hinges 18 supporting the display panel. Such arrangement makes full uses of the space available inside hinges 18 and gives laptop computer 10 a more appealing look.

Laptop computer 10 further comprises a keyboard 17, wherein a plurality of user-defined function keys 19 is available. One of these, function key 13, is defined and configured to be the key switch for switching between the IEEE802.11 module and the bluetooth module according to the present invention. The user simply depresses key switch 13 and switching from one wireless system to the other is performed, which, compared to practices of the prior art where the user must move the mouse to point to and click an icon and can only manage one wireless system, allows fast manual operation and system response, while providing at the same time options between two wireless apparatuses to be utilized at the will of the user, thereby resulting in a great improvement over the prior art.

Moreover, in order to inform the user which module is under use when he switches between the IEEE802.11 system and the bluetooth system according to the present invention, a display window 15 is mounted near key switch 13 which reminds the user of the status of the two wireless apparatuses by emitting light of different colors signifying different status thereof.

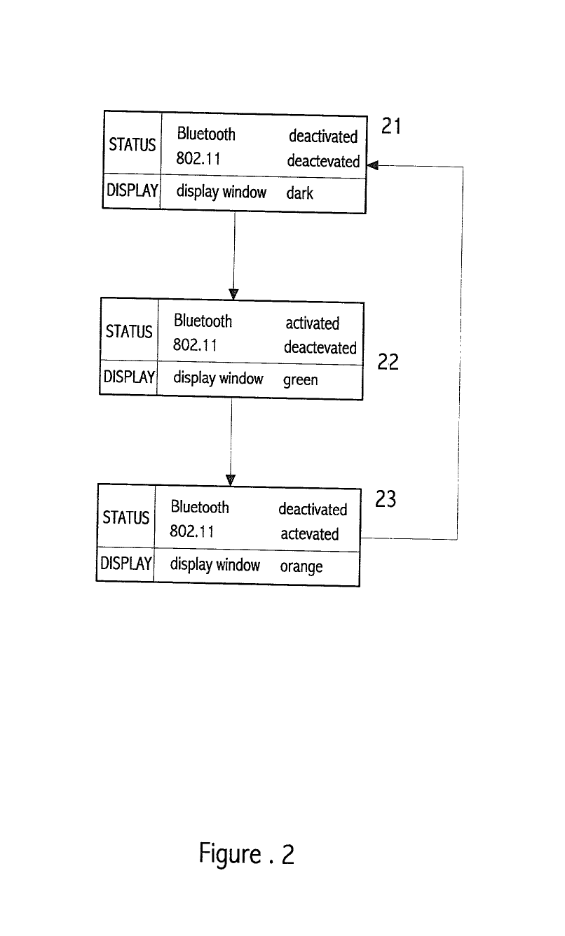

FIG. 2 illustrates the possibly different states of the two wireless communication apparatuses according to present invention, wherein display window 17 is a light emitting diode (LED) capable of displaying light of different colors. According to one embodiment of the present invention, in initial status 21, both the IEEE802.11 system and the bluetooth system are deactivated (turned off) and display window 17 is dark. After the depression of key switch 13, status 22 is entered, where the bluetooth system is activated (turned on) while the IEEE802.11 system remains off and display window 17 turns into color green. Similarly, after the depression of key switch 13 again, status 23 is entered, where the bluetooth system is turned off while the IEEE802.11 system is turned on and display window 17 turns into color orange. Finally, after another depression of key switch 13, status 21 is recovered, where the bluetooth system and the IEEE802.11 system are both off and display window 17 turns into dark. Thus it is understood that the key switch 13 performs switching in a cyclic pattern, thereby allowing the user to switch between the bluetooth system and the IEEE802.11 system in a cyclic way through depression of the key switch 13. In addition the colored light displayed through the display window 15 serves as a reminder so as to have the user aware of the present status of the two wireless apparatuses, just in case that he has forgotten in which state they are. In one embodiment of the present invention, display window 17 turns into blue when the bluetooth system is activated, suggesting to the user that it is bluetooth system that is activated.

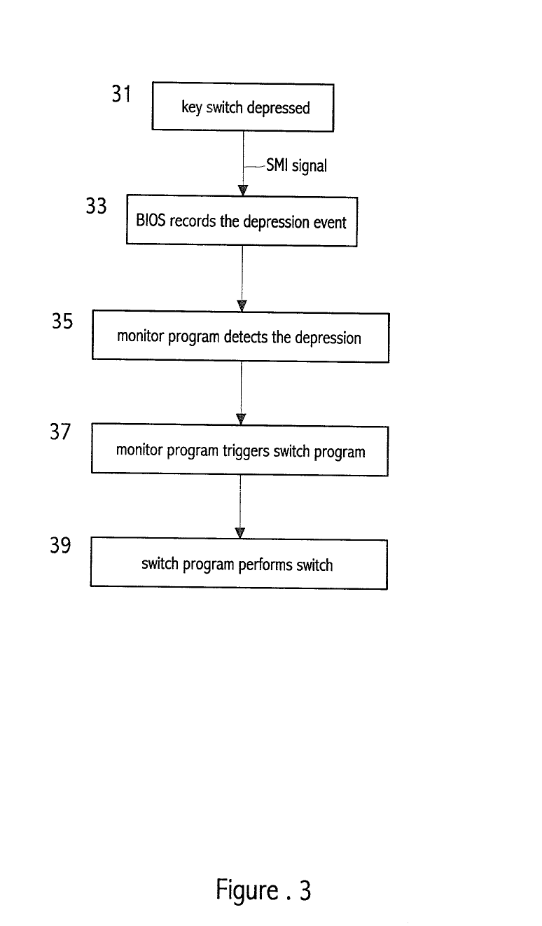

FIG. 3 illustrates a flow chart of one embodiment of the key switch system for wireless communication apparatuses according to the present invention. It is understood by those skilled in the art that the bluetooth system and the IEEE802.11 system require their own driver programs to work properly and therefore, in the present invention, both driver programs are installed into the operating system of the computer system along with the installation of the two wireless communication modules. In the embodiment of the present invention, a switch program integrates the driver programs in a way that, in cooperation with the key switch 13, facilities switching from one status of the wireless apparatuses to the other. Furthermore, a monitor program running in the background detects or monitors the depression of the key switch 13, and thereby calls the switch program to switch the status in a cyclic pattern as described above when depression is detected. While one of the wireless apparatuses is activated (turned on), the switch program deactivates (turns off) the other and makes sure that the bluetooth system and the IEEE802.11 system are not working at the same time and thus not interfering with each other.

The sequences are as below. First, upon depression of the key switch 13 in step 31, a SMI (system management interrupt) signal is generated and transmitted to BIOS (basic input and output system). After reception of the SMI signal representing the depression by the BIOS in step 33, the depression event is recorded on a particular section of CMOS (complementary metal oxide semiconductor) memory. Subsequently after the recording, the depression event is detected in step 35 by the monitor program that keeps polling, or requesting for, data stored in said section of the CMOS memory. And in step 37 the monitor program triggers the switch program after the depression event is detected. Finally in step 39, the switch program calls the driver programs and switches the status of the two wireless apparatuses according to the then present status in a cyclic pattern as described above.

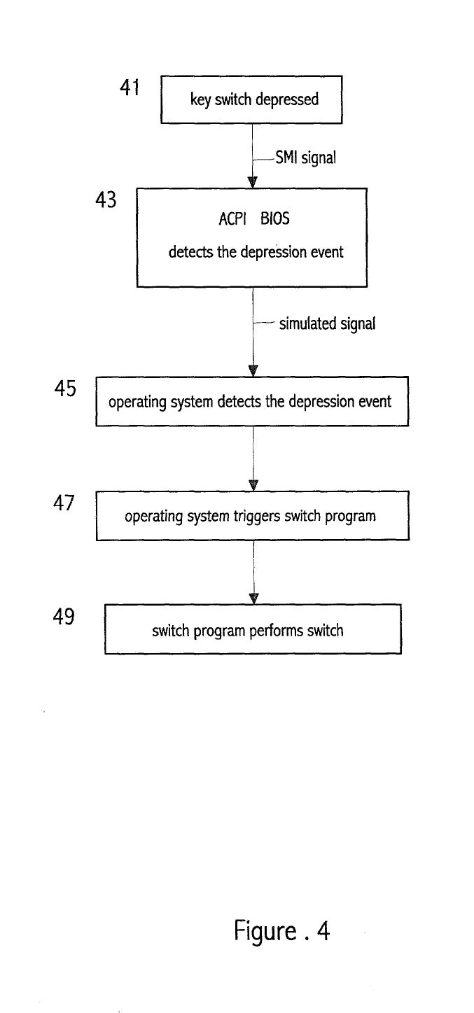

FIG. 4 illustrates the flow chart of another embodiment of the key switch system for wireless communication apparatuses according to present invention, wherein the APCI (advanced configuration & power interface) provided by the WINDOWS operating system is employed, after receiving the SMI signal generated upon the depression of the key switch 13, to generate a simulated hardware insertion (or withdrawal) signal relating to the depression event. After the simulated signal is detected by the operating system, the status of the bluetooth system and the IEEE802.11 system is switched from the then present one to the other in a cyclic pattern described above.

The sequences are as below. First, upon depression of the key switch 13 in step 41, a SMI signal is generated and transmitted to APCI BIOS. After reception of the SMI signal representing the depression by the APCI BIOS in step 43, a simulated hardware insertion (or withdrawal) signal, which corresponds to the depression event, is generated according APCI specifications and is then transmitted to the operating system. Subsequently, in step 45, the operating system receives the simulated signal corresponding to the depression and, in step 47, triggers the switch program. Finally in step 49, the switch program calls the driver programs and switches the status of the two wireless apparatuses according to the then present status in a cyclic pattern described above.

Having disclosed and described the embodiments and features of present invention, it is realized that the key switch for incompatible wireless communication apparatuses installed on a laptop or other computer systems has several advantages over prior art. It is capable of managing two different incompatible apparatuses at the same time, without one interfering with the other, and thereby gives the user flexible utilities. Moreover, it precludes unnecessary manual operations of moving the mouse and pointing to particular icons and thus provides an easier controlling interface.

It is to be noted that the embodiments and particular features and functions as disclosed above are for the purpose of disclosure only and are not in any sense for limiting the scope of the invention. Small modifications and juxtapositions of one or more of the functional elements anticipated by those skilled in the art without departing the spirit of present invention is to be regarded as a part of the invention.

For example, although the embodiments disclosed refer to a computer system comprising two mutually incompatible wireless communication apparatuses, it is possible that one may add another one or more wireless communication apparatuses so that the computer system may comprise several wireless communication apparatuses all of which function properly according to the invention.

For another example, the display window could be a liquid crystal display (LCD) that displays the status of the wireless apparatuses either in text or by icons or colors.

Therefore, that the scope of the present invention is determined by the appended claims is fully understood.

What is claimed is:

1. A key switch system for switching in a cyclic pattern between a plurality of wireless communication apparatuses of a computer, comprising:
a function key, mounted on the computer, for generating an interrupt signal after depression;
software for activating and deactivating the wireless communication apparatuses according to the signal, with one activated at a time; and
a display window for displaying the activated/deactivated status of the wireless communication apparatuses;
wherein cyclic switching between the wireless communication apparatuses is enacted by the depression of the function key.

2. The key switch system according to claim 1, wherein at least one of the wireless communication apparatuses is incompatible with another one of the communication apparatuses.

3. The key switch system according to claim 1, wherein the software is able to simultaneously deactivate all of the wireless communication apparatuses.

4. The key switch system according to claim 3, wherein the cyclic pattern follows the sequence of:
a) activating, in turn, each one of the apparatuses in a round; and
b) deactivating all of the apparatuses after a round is finished and repeating a).

5. The key switch system according to claim 1, wherein one of the wireless communication apparatuses employes the IEEE802.11 protocol.

6. The key switch system according to claim 1, wherein one of the wireless communication apparatuses employes the bluetooth protocol.

7. The key switch system according to claim 1, wherein the display window is a light emitting diode (LED) with which different colored light corresponding to dirrerent status of the wireless communication apparatuses can be displayed.

8. The key switch system according to claim 7, wherein the display window turns into blue when bluetooth system is activated.

9. The key switch system according to claim 1, wherein the display window is a liquid crystal display (LCD).

10. The key switch system according to claim 1, wherein the wireless communication apparatuses are activated and deactivated through calling drivers associated with the wireless communication apparatuses by the software.

11. A key switch system for switching in a cyclic pattern between a IEEE802.11 wireless communication apparatus and a bluetooth wireless communication apparatus of a computer, comprising:
a function key, mounted on the computer, for generating an interrupt signal after depression;
software for activating and deactivating the wireless communication apparatuses according to the signal, with one activated at a time; and
a display window for displaying the activated/deactivated status of the two wireless communication apparatuses;
wherein cyclic switching between the wireless communication apparatuses is enacted by the depression of the function key.

12. The key switch system according to claim 1, wherein the software is able to simultaneously deactivate both of the wireless communication apparatuses.

13. The key switch system according to claim 13, wherein the cyclic pattern follows the sequence of:
a) activating in turn each of the apparatuses in a round; and
b) deactivating both of the apparatuses after a round is finished and repeating a).

14. The key switch system according to claim 1, wherein the display window is a light emitting diode (LED) with which different colored light corresponding to dirrerent status of the wireless communication apparatuses can be displayed.

15. The key switch system according to claim 15, wherein the display window turns into blue when the bluetooth system is activated.

16. The key switch system according to claim 1, wherein the display window is a liquid crystal display (LCD).

17. The key switch system according to claim 1, wherein the wireless communication apparatuses are activated through triggering drivers associated with the wireless communication apparatuses by the software.
